(19) United States
(12) Patent Application Publication
(10) Pub. No.: US 2020/0151238 A1
(43) Pub. Date: May 14, 2020

(54) Processor and Methods Configured to Provide a Low-Complexity Input/Output Pruning Fast Fourier Transform

(71) Applicant: Jaber Technology Holdings US Inc, Quebec (CA)

(72) Inventors: Marwan A. Jaber, Saint-Leonard (CA); Radwan A. Jaber, Saint-Leonard (CA)

(73) Assignee: Jaber Technology Holdings US Inc, Quebec (CA)

(21) Appl. No.: 16/444,946

(22) Filed: Jun. 18, 2019

Related U.S. Application Data
(60) Provisional application No. 62/686,453, filed on Jun. 18, 2018.

(51) Int. Cl. G06F 17/14; G06F 7/49; G06F 7/501; G06F 7/57; G06F 9/30

(52) U.S. Cl. CPC G06F 17/142; G06F 7/49; G06F 9/3001; G06F 7/57; G06F 7/501

(57) ABSTRACT

In some embodiments, a circuit may include an input configured to receive a signal and a radix-r input/output pruning fast Fourier transform (FFT) processing element coupled to the input. The radix-r input/output pruning FFT processing element may be configured to remove FFT operations on input values of zero within the signal and to determine a discrete Fourier Transform (DFT) output having fewer output values than a number of input values of the signal.

### CROSS-REFERENCE TO RELATED APPLICATION(S)

This application is a non-provisional of and claims priority to U.S. Provisional Patent Application No. 62/686,453 filed on Jun. 18, 2018 and entitled “Processor and Methods Configured to Provide a Low-Complexity Input/Output Pruning Fast Fourier Transform”, which is incorporated herein by reference in its entirety.

### FIELD

The present disclosure is generally related to digital signal processing systems configured to perform fast Fourier transformations (FFT), and more particularly to a low-complexity input/output pruning FFT.

### BACKGROUND

Input pruning FFTs are commonly used in the padded FFT process which is known as the up-sampling process in digital signal processing that consists of extending a signal (or spectrum) with zeros. By doing so, this can increase the time sampling which is known as the time domain interpolation that people commonly use, and which is translated into forcing the FFT algorithm to sample the spectrum at smaller frequency intervals.

### SUMMARY

FFTs algorithms are used in digital signal processing which break down complex signals into elementary components and where the transform length N, is decomposed into arbitrary factors (N=r1, r2, . . . , rk). Input Pruning FFT's are efficient Fast Fourier Transform (FFT), where the efficiency can be increased by removing operations on input values which are zero. Furthermore, Output pruning FFT is a method used to compute a discrete Fourier transform (DFT) where only a subset of the outputs is needed. In this embodiments, we will propose a generalized radix-r input-output pruning FFT, which will compute efficiently the selected spectrum's bin of a sequence of size N that contains M consecutive non-zero input points from which only Lo outputs are desired.

In some embodiments, a circuit may include an input configured to receive a signal and a radix-r input/output pruning fast Fourier transform (FFT) processing element coupled to the input. The radix-r input/output pruning FFT processing element may be configured to remove FFT operations on input values of zero within the signal and to determine a discrete Fourier Transform (DFT) output having fewer output values than a number of input values of the signal.

### BRIEF DESCRIPTION OF THE DRAWINGS

FIG. 1 depicts a portion of a system including a digital signal processor configured to provide a generalized radix-r input/output pruning FFT, in accordance with certain embodiments of the present disclosure.

FIG. 2 depicts a graph of real operations reduction versus input pruning for the generalized radix-r input/output pruning FFT of FIG. 1.

FIG. 3 depicts a graph of a complexity ratio of the generalized radix-r input/output pruning FFT according to some embodiments of the present disclosure versus a conventional input pruning FFT.

FIG. 4 depicts a graph of a number of operations versus a number of output elements for the generalized radix-r input/output pruning FFT according to some embodiments of the present disclosure versus a pruning FFT implementation.

FIG. 5 depicts a graph of a reduction ratio of operations versus a number of output elements, for the generalized radix-r input/output pruning FFT according to some embodiments of the present disclosure versus a pruning FFT implementation.

FIG. 6 depicts a graph representing a magnified version of the graph of FIG. 5.

FIG. 7 depicts a graph of signal-to-quantization-noise ratio (SQNR) in decibels versus number of output elements without filtering for the generalized radix-r input/output pruning FFT, in accordance with some embodiments of the present disclosure.

FIG. 8 depicts a graph of signal-to-quantization-noise ratio (SQNR) in decibels versus number of output elements with filtering for the generalized radix-r input/output pruning FFT, in accordance with some embodiments of the present disclosure.

FIG. 9 depicts a graph of a number of operations versus number of input/output elements for the generalized radix-r input/output pruning FFT according to some embodiments of the present disclosure versus a pruning FFT implementation.

FIG. 10 depicts a graph of the reduction ratio of operations versus the number of output elements for the generalized radix-r input/output pruning FFT, in accordance with some embodiments of the present disclosure.

FIGS. 11 and 12 depict the software implementation of sequences that have Lᵢ (multiple of the FFT radix-r) consecutive non-zero input points at any position n (n is multiple of the FFT radix-r) within the sequence and not necessarily at the beginning.

In the following discussion, the same reference numbers are used in the various embodiments to indicate the same or similar elements.

### DETAILED DESCRIPTION OF ILLUSTRATIVE EMBODIMENTS

Theoretical aspects of the Pruning FFT (PFFT) have mainly concentrated on sequences that have Lᵢ consecutive non-zero input points at the beginning. In many applications, such as the Orthogonal Frequency-Division Multiplexing (OFDM)-based Cognitive Radio may utilize FFT pruning, which can apply zeros efficiently to the inputs with arbitrary distributions.

In many applications, the percentage of required input/output bins may be very small. For instance, in the Third Generation Partnership Project (3GPP) LTE (Long Term Evolution) where the Orthogonal Frequency-Division Multiple Access OFDMA's symbol size is 1024 in which 12 users equally share the available 600 sub-carriers, only fifty of the 1024 FFT output bins (4.88%) may be used for each mobile terminal. These partial output/input cases are extraordinarily important for the future wireless systems and due to the fact that the pruning FFT (PFFT) can potentially achieve a significant speed improvement, which is desirable for a wide variety of applications such as: OFDMA (Orthogonal Frequency Division Multiplexing Access) cognitive radio, Very long instruction word (VLIW) digital signal processing (DSP) for mobile Applications, multi-channel OFDM systems, Multiple Input Multiple Output—Orthogonal Frequency Division Multiplexing (MIMO-OFDM) systems, and other applications.

Embodiments of a generalized radix-r input-output pruning FFT are described below that can be used to determine efficiently a selected spectrum's bin of a sequence input values of size N that contains M consecutive non-zero input points from which only Lₒ outputs are desired. In certain embodiments, the FFT may be used to compute a discrete Fourier transform (DFT) where only a subset of the outputs are needed, such that for a transform of size M which has been zero padded to a size N and where only Lₒ≤P consecutive outputs of the sized N transform are desired, the FFT can produce P consecutive outputs determined from the Lᵢ non-zero consecutive inputs and where it is assumed that Lₒ/Dᵢₚ≈P=M/Dₒₚ. Other embodiments are also possible.

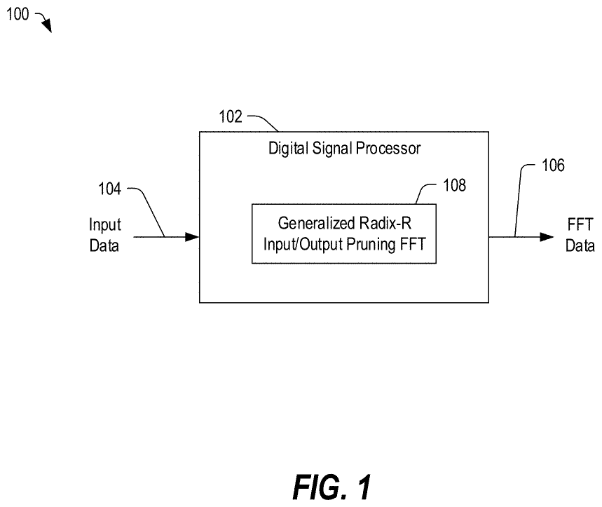

It should be appreciated that the generalized radix-r input/output pruning FFT disclosed herein may be implemented in a digital signal processor executing instructions, in a field-programmable gate array circuit, or in other hardware or software. Further, the operation or execution of the operations defined by the generalized radix-r input/output pruning FFT may improve the speed of the processing of the input data values, while reducing the number of operations and improving the overall efficiency of the circuit. Further, the resulting FFT output values may be used in a variety of contexts, including image processing, audio processing, encryption and decryption, and so on. One possible implementation of the FFT algorithm in a digital signal processor is described below with respect to FIG. 1.

FIG. 1 depicts a portion of a system 100 including a digital signal processor 102 configured to provide a generalized radix-r input/output pruning FFT, in accordance with certain embodiments of the present disclosure. The digital signal processor (DSP) 102 may include an input 104 to receive input data and may include an output 106 configured to provide FFT data as an ordered output.

In some embodiments, the DSP 102 may be configured to execute instructions including a generalized radix-r input/output pruning FFT 108, which may be configured to reduce the overall number of computations and memory accesses needed to determine the ordered FFT output. The FFT 108 is depicted as a block within the DSP 102 to indicate that the instructions were previously loaded by the DSP 102; however, the FFT 108 may be stored as instructions within a memory (read-only memory, random access memory, solid state memory, hard disc device, or any combination thereof) and may be loaded and executed by the DSP 102 as needed.

The basis of the radix-2 FFT is that a DFT can be divided into two smaller DFTs, each of which can be divided into two smaller DFTs, and so on, resulting in a combination of two points DFTs. Several methods can be used repeatedly to split the DFTs into smaller (two or four-point) core calculations. By appropriately breaking the DFT into partial DFTs in this way, the number of multiplications and the number of stages of the DFT calculation may be controlled. The number of stages often corresponds to the amount of global communication and/or memory accesses, and thus, a reduction in the number of stages is beneficial (in terms of speed and complexity).

The DSP 102 of FIG. 1 may be configured to apply a recursive general radix-r pruned FFT that is suitable for pruned FFTs at the input 104 where the pruning FFT applied by the DSP 102 has fewer complex multiplications than conventional pruning FFT algorithms. The recursive generalized radix-r pruned FFT shows substantial gain in the computational load and a significant increase in speed due to the reduction of the number of stages, which translates to a reduction in the number of data transfers and address computations.

The generalized radix-r pruned FFT can formulate the radix-r as composed engines with identical structures and a systematic means of accessing the corresponding multiplier coefficients. This formulation may enable the design of an engine with the lowest rate of complex multipliers and adders, which utilizes r or r−1 complex multipliers in parallel to implement each of the butterfly computations. There can be a simple mapping from the three indices (FFT stage, butterfly, and element) to the addresses of the multiplier coefficients needed in the DFT computation.

The DFT computation may be expressed as follows:

X₍ₖ₎=Σₙ₌₀^{N-1}x₍ₙ₎w_{N}^{nk} for k=0,1, . . . ,N−1, (Equation 1)

where

$${w}_{N}^{k} = {e}^{- j \frac{2 π k}{N}} .$$

Considering that the number of consecutive input elements Lᵢ that can be different from zero is Lᵢ≤M=N/Dᵢₚ, where the variable N represents a number of input bits and the variable Dᵢₚ represents a threshold value. Equation 1 could be factorized as follows:

$$\begin{matrix}{X}_{( k )} = {\sum }_{n = 0}^{N - 1} {x}_{( n )} {w}_{N}^{nk} \\ = {\sum }_{{n}_{2} = 0}^{{D}_{ip} - 1} {\sum }_{{n}_{1} = 0}^{M - 1} {x}_{( {n}_{1} + {Mn}_{2} )} {w}_{N}^{( {n}_{1} + {Mn}_{2} ) k} \\ = {\sum }_{{n}_{2} = 0}^{{D}_{ip} - 1} {w}_{N}^{{Mn}_{2} k} {\sum }_{{n}_{1} = 0}^{M - 1} {x}_{( {n}_{1} + {Mn}_{2} )} {w}_{N}^{{n}_{1} k} ,\end{matrix} \qquad ( Equation 2 )$$

with the following identities:

n=n₁+Mn₂ k=k₁+Dᵢₚk₂

n₁=0,1, . . . ,M−1 k₁=0,1, . . . ,Dᵢₚ−1

n₂=0,1, . . . ,Dᵢₚ−1 k₂=0,1, . . . ,M−1. (Equation 3)

The indices n₂ may determine the position of the nonzero consecutive inputs into the sequence where zeroes have been applied efficiently to the inputs with arbitrary distributions. With respect to input data sequences that have Lᵢ consecutive non-zero input points at the beginning, the index n₂ can be set to zero. As a result, Equation 3 may be rewritten as follows:

X₍ₖ₎=Σₙ₌₀^{M-1}x₍ₙ₎w_{N}^{n(k}^{₁}^{+Dipk}^{₂}⁾=Σₙ₌₀^{M-1}x₍ₙ₎w_{N}^{nk}^{₁}w_{M}^{k}^{₂}. (Equation 4)

The computational complexity of Equation 4 can be performed in two ways. The following paragraphs elaborate on a comparison between these two methods.

A first method may be referred to as the “direct way” or “direct method” in which Equation 3 can be expressed as follows:

X₍ₖ₎=Σₙ₌₀^{M-1}x₍ₙ₎w_{N}^{nk}^{₁}w_{M}^{k}^{₂}=Σₙ₌₀^{M-1}y₍ₙ₎w_{M}^{k}^{₂}. (Equation 5)

where y₍ₙ₎ can be expressed as follows:

y₍ₙ₎=x₍ₙ₎w_{N}^{nk}^{₁}. (Equation 6)

The computational complexity of Equation 4 can be determined as follows:

t_{c-input}=DᵢₚM(t_{cFFT}_{_{M}}+t_{cm})=N(t_{cFFT}_{_{M}}+t_{cm}), (Equation 7)

where the variable t_{cFFT} represents the complexity of the FFT algorithm of size M, and the variable t_{cm} is the complexity of the complex multiplier.

Logically, the optimal solution of Equation 5 may be obtained by optimizing the complexity of the FFT algorithm, where conventional researchers have been oriented in the optimization of the FFT algorithm, and not the complexity. According to embodiments of the present disclosure, a method of optimizing Equation 5 could be achieved by incorporating the twiddle factors w_{N}^{nk}^{₁} and the adder tree matrices into a single stage of calculation.

In the following discussion, this simplification is demonstrated relative to a radix-2 FFT in which the split radix algorithm has been excluded. The complexity of the Cooley-Tukey (radix-2 FFT) algorithm in term of complex multiplication can be determined as follows:

$${t}_{c m \text{-} cooley \text{-} tukey} = \frac{M}{2} ( {log}_{2} M ) = \frac{M}{2} {S}_{M} , \qquad ( Equation 8 )$$

where the variable S_{M}=log₂ M. On the other hand, each radix-2 butterfly may require two complex additions/subtractions. As a result, the total number of complex of additions/subtractions in t_{ca/s} DIT process may be determined as follows:

$${t}_{ca / s \text{-} cooley \text{-} tukey} = ( \frac{M}{2} ) {log}_{2} M . \qquad ( Equation 9 )$$

It should be appreciated that each complex multiplication can require six arithmetic operations, and each addition/subtraction can require two arithmetic operations. Therefore, the total number tₒ of the arithmetic operations in the DIT Cooley-Tukey algorithm can be estimated as follows:

$${t}_{o \text{-} cooley \text{-} tukey} = 6 ( \frac{M}{2} ) {S}_{M} + 2 ( \frac{M}{2} ) ( {S}_{M} ) = 4 {MS}_{M} = 4 M {log}_{2} M , \qquad ( Equation 10 )$$

Accordingly, the total amount of arithmetic operations required to compute the input pruning FFT can be determined as follows:

t_{c-input-Puning_Medina}=DᵢₚM(4MS_{M}+M+6)=N(4M log₂ M−3M+6). (Equation 11)

According to some embodiments, the low-complexity input/output (I/O) pruning FFT utilizes radix-r DFT factorization, and Equation 5 can be re-written as follows:

$${X}_{( {k}_{1} , {k}_{2} )} = {\sum }_{n = 0}^{\frac{M}{r} - 1} {x}_{( rn )} {w}_{N}^{{rnk}_{1}} {w}_{M}^{{rnk}_{2}} + … + {\sum }_{n = 0}^{\frac{M}{r} - 1} {x}_{( {rn}_{1} + ( r - 1 ) )} {w}_{N}^{( rn + ( r - 1 ) ) {k}_{1}} {w}_{M}^{( rn + ( r - 1 ) ) {k}_{2}} . \qquad ( Equation 12 )$$

In the summations, the variables r, k₁ and k₂ are independents of the variable n₂. The variable w_{M}^{rk}^{₂} in Equation 12 and be factorized, and, considering that w_{M}^{rnk}^{₂}=w_{M/r}^{nk}^{₂}, Equation 12 can be rewritten as follows:

$${X}_{( {k}_{1} , {k}_{2} )} = {\sum }_{n = 0}^{\frac{M}{r} - 1} {x}_{( rn )} {w}_{\frac{M}{r}}^{{nk}_{2}} {w}_{\frac{N}{r}}^{{nk}_{1}} + {w}_{M}^{{k}_{2}} {w}_{N}^{{k}_{1}} {\sum }_{n = 0}^{\frac{M}{r} - 1} {x}_{( rn + 1 )} {w}_{\frac{M}{r}}^{{nk}_{2}} {w}_{\frac{N}{r}}^{{nk}_{1}} + … + {w}_{M}^{( r - 1 ) {k}_{2}} {w}_{N}^{( r - 1 ) {k}_{1}} {\sum }_{n = 0}^{\frac{M}{r} - 1} {x}_{( rn + ( r - 1 ) )} {w}_{\frac{M}{r}}^{{nk}_{2}} {w}_{\frac{N}{r}}^{{nk}_{1}} . \qquad ( Equation 13 )$$

To subdivide the axis k₂ in Equation 13 in two new axes (v and l), it is assumed that k₂=v+lV with v=0, 1, . . . , V−1 and l=0, 1, . . . , r−1 where V=M/r. Therefore, the variable X₍ₖ_{₁}_{+D}_{ᵢₚ}ₖ_{₂}₎ can be replaced using new indices v and l with k₁=0, 1, . . . , Dᵢₚ−1. As a result, Equation 13 can be rewritten in r equations as shown below in Equation 14, Equation 15, and Equation 16.

$${X}_{( {k}_{1} , v )} = [ \begin{matrix}{w}_{M}^{0} {\sum }_{n = 0}^{\frac{M}{r} - 1} {x}_{( rn )} {w}_{M / r}^{nv} {w}_{\frac{N}{r}}^{{nk}_{1}} + \\ … + {w}_{M}^{( r - 1 ) v} {w}_{N}^{( r - 1 ) {k}_{1}} {\sum }_{n = 0}^{\frac{M}{r} - 1} {x}_{( rn + ( r - 1 ) )} {w}_{M / r}^{nv} {w}_{\frac{N}{r}}^{{nk}_{1}}\end{matrix} ] \\ {X}_{( {k}_{1} , 2 v )} = [ \begin{matrix}{w}_{M}^{0} {\sum }_{n = 0}^{\frac{M}{r} - 1} {x}_{( rn )} {w}_{M / r}^{2 nv} {w}_{\frac{N}{r}}^{{nk}_{1}} + \\ … + {w}_{M}^{( r - 1 ) v} {w}_{N}^{( r - 1 ) {k}_{1}} {\sum }_{n = 0}^{\frac{M}{r} - 1} {x}_{( rn + ( r - 1 ) )} {w}_{M / r}^{2 nv} {w}_{\frac{N}{r}}^{{nk}_{1}}\end{matrix} ] \\ ⋮ \\ {X}_{( {k}_{1} , ( v + ( r - 1 ) V ) )} = [ \begin{matrix}{w}_{M}^{0} {\sum }_{n = 0}^{\frac{M}{r} - 1} {x}_{( rn )} {w}_{M / r}^{n ( v + ( r - 1 ) V )} {w}_{\frac{N}{r}}^{{nk}_{1}} + \\ … + {w}_{M}^{( r - 1 ) ( v + ( r - 1 ) V )} {w}_{N}^{( r - 1 ) {k}_{1}} \\ {\sum }_{n = 0}^{\frac{M}{r} - 1} {x}_{( rn + ( r - 1 ) )} {w}_{M / r}^{n ( v + ( r - 1 ) V )} {w}_{\frac{N}{r}}^{{nk}_{1}}\end{matrix} ] . \qquad ( Equation 14 )$$

Considering that the variable w_{V}^{αV}=(w_{V}^{V})^{α}=1^{α}=1 and V=M/r, Equation 14 could be expressed as follows:

$$\begin{matrix}{X}_{( {k}_{1} , ( v + V ) )} = [ \begin{matrix}{w}_{M}^{0} {\sum }_{n = 0}^{\frac{M}{r} - 1} {x}_{( rn )} {w}_{M / r}^{ nv} {w}_{\frac{N}{r}}^{{nk}_{1}} + … \\ + {W}_{M}^{( r - 1 ) \frac{M}{r}} {w}_{M}^{( r - 1 ) v} {w}_{N}^{( r - 1 ) {k}_{1}} {\sum }_{n = 0}^{\frac{M}{r} - 1} {x}_{( rn + ( r - 1 ) )} {w}_{M / r}^{nv} {w}_{\frac{N}{r}}^{{nk}_{1}}\end{matrix} ] \\ ⋮ \\ {X}_{( {k}_{1} , ( v + ( r - 1 ) V ) )} = [ \begin{matrix}{w}_{M}^{0} {\sum }_{n = 0}^{\frac{M}{r} - 1} {x}_{( rn )} {w}_{M / r}^{nv} {w}_{\frac{N}{r}}^{{nk}_{1}} + \\ … + {w}_{M}^{{( r - 1 )}^{2} \frac{M}{r}} {w}_{M}^{( r - 1 ) v} {w}_{N}^{( r - 1 ) {k}_{1}} {\sum }_{n = 0}^{\frac{M}{r} - 1} {x}_{( rn + ( r - 1 ) )} {w}_{M / r}^{nv} {w}_{\frac{N}{r}}^{{nk}_{1}}\end{matrix} ] , & ( Equation 15 ) \\ {X}_{( {k}_{1} , v )} = ( \begin{matrix}{X}_{( v )} \\ {X}_{( v + V )} \\ ⋮ \\ {X}_{( v + ( r - 1 ) V )}\end{matrix} ) = ( \begin{matrix}{w}_{N}^{0} & {w}_{N}^{0} & … & {w}_{N}^{0} \\ {w}_{N}^{0} & {w}_{N}^{N / r} & … & {w}_{N}^{( r - 1 ) ( N / r )} \\ ⋮ & ⋮ & ⋱ & ⋮ \\ {w}_{N}^{0} & {w}_{N}^{( r - 1 ) ( N / r )} & … & {w}_{N}^{{( r - 1 )}^{2} ( N / r )}\end{matrix} ) \times ( \begin{matrix}{w}_{N}^{0} & 0 & … & 0 \\ 0 & {w}_{N}^{{D}_{ip} v} {w}_{N}^{{k}_{1}} & ⋮ & ⋮ \\ ⋮ & ⋮ & ⋱ & ⋮ \\ 0 & … & 0 & {w}_{N}^{{D}_{ip} ( r - 1 ) v} {w}_{N}^{( r - 1 ) {k}_{1}}\end{matrix} ) \times [ \begin{matrix}{\sum }_{n = 0}^{\frac{M}{r} - 1} {x}_{( rn )} {w}_{\frac{M}{r}}^{nv} {w}_{\frac{N}{r}}^{{nk}_{1}} \\ {\sum }_{n = 0}^{\frac{M}{r} - 1} {x}_{( rn + 1 )} {w}_{\frac{M}{r}}^{nv} {w}_{\frac{N}{r}}^{{nk}_{1}} \\ ⋮ \\ {\sum }_{n = 0}^{\frac{M}{r} - 1} {x}_{( rn + ( r - 1 ) )} {w}_{\frac{M}{r}}^{nv} {w}_{\frac{N}{r}}^{{nk}_{1}}\end{matrix} ] . & ( Equation 16 )\end{matrix}$$

The first matrix, the well-known adder tree matrix Tᵣ, and the second matrix can be known collectively as an Input Pruning FFT twiddle factor matrix W_{N}, respectively. Equation 16 can be expressed in a compact form as follows:

$${x}_{( {k}_{1} + {D}_{ip} ( v + lV ) )} = {X}_{( {k}_{1} , {k}_{2} )} = {T}_{M} {W}_{N} col ( {\sum }_{n = 0}^{V - 1} {x}_{( rn + l )} {w}_{V}^{nv} {w}_{\frac{N}{r}}^{{nlk}_{1}} \vert l = 0 , 1 , … , r - 1 ) , \qquad ( Equation 17 )$$

fork₁=0, 1, . . . , Dᵢₚ−1 and v=0, 1, . . . , V−1, where the variable X₍ₖ_{₁}_{,k}_{₂}₎ can be expressed as follows:

$${X}_{( {k}_{1} , {k}_{2} )} = {[ {\sum }_{n = 0}^{V - 1} {x}_{( rn + l )} {w}_{V}^{nv} {w}_{\frac{N}{r}}^{{nlk}_{1}} \vert l = 0 , 1 , … , r - 1 ]}^{T} . \qquad ( Equation 18 )$$

Further, the variable (W_{N}) can be expressed as follows:

W_{N}=diag(w_{N}^{D}^{ᵢₚ}^{lv}w_{N}^{lk}^{₁}|l=0,1, . . . ,r−1), (Equation 19)

and the matrix T_{M} can be expressed as follows:

$${T}_{M} = ( \begin{matrix}{w}_{M}^{0} & {w}_{M}^{0} & {w}_{M}^{0} & … & … & {w}_{M}^{0} \\ {w}_{M}^{0} & {w}_{M}^{M / r} & {w}_{M}^{2 M / r} & … & … & {w}_{M}^{( r - 1 ) M / r} \\ {w}_{M}^{0} & {w}_{M}^{2 M / r} & {w}_{M}^{4 M / r} & … & … & {w}_{M}^{2 ( r - 1 ) M / r} \\ ⋮ & ⋮ & ⋮ & ⋱ & ⋮ & ⋮ \\ ⋮ & ⋮ & ⋮ & ⋱ & ⋱ & ⋮ \\ {w}_{M}^{0} & {w}_{M}^{( r - 1 ) M / r} & {w}_{M}^{2 ( r - 1 ) M / r} & … & … & {w}_{M}^{{( r - 1 )}^{2} M / r}\end{matrix} ) \qquad ( Equation 20 )$$

In terms of the digital signal processor, the factorization of the FFT can be interpreted as dataflow, which depicts the arithmetic operations and their dependencies. When Equation 16 is read from left to right, the decimation in frequency (DIF) algorithm can be obtained. When Equation 16 is read from right to left, the decimation in time (Equation DIT) algorithm can be determined. It should be noted that the DIF algorithm may require one shuffling stage in order to obtain ordered output data.

The write address generator (WAG) can be determined as follows:

WAG=lV+v. (Equation 21)

The read address generator zRAG) can be determined as follows:

$$RAD = {n}_{1} ( \frac{m}{{r}^{( s + 1 )}} ) + {〚 v 〛}_{{r}^{( {S}_{M} - s )}} + ⌊ \frac{v}{{r}^{( {S}_{M} - s )}} ⌋ {r}^{( {S}_{M} + 1 - s )} . \qquad ( Equation 22 )$$

Further, the DIT Coefficient address generator (CAG) can be determined as follows:

$$CAG = {〚 {n}_{1} ( {D}_{ip} ( lV + ⌊ \frac{v}{{r}^{( {S}_{M} - s )}} ⌋ {r}^{( {S}_{M} - s )} ) + ( {r}^{( {S}_{M} - s )} {k}_{1} ) ) 〛}_{N} , \qquad ( Equation 23 )$$

where the variable [[x]]_{N} can represent the operation x modulo N; the variable └x┘ may represent the integer part operator of x; the indices are v=0, 1, . . . , V−1; the variable s=0, 1, . . . , S_{M}; the variable r is the radix-r, the variable V is the number of words

$$( V = \frac{M}{r} ) ,$$

and the variable S_{M} is the number of stages (S_{M}=logᵣ M−1). Accordingly, the low-complexity I/O pruning FFT can be determined as follows:

X₍ₖ_{₁}_{+D}_{ᵢₚ}_{×k}_{₂}₎=X₍ₖ_{₁}_{+D}_{ᵢₚ}_{×k}_{₂}_{,s+1,v,w}_{_{ag}}₎=Σₙ₌₀^{r-1}[X₍ₖ_{₁}_{+D}_{ᵢₚ}_{×k}_{₂}_{,s,v,R}_{_{ad}}₎w_{M}^{CAG}] (Equation 24)

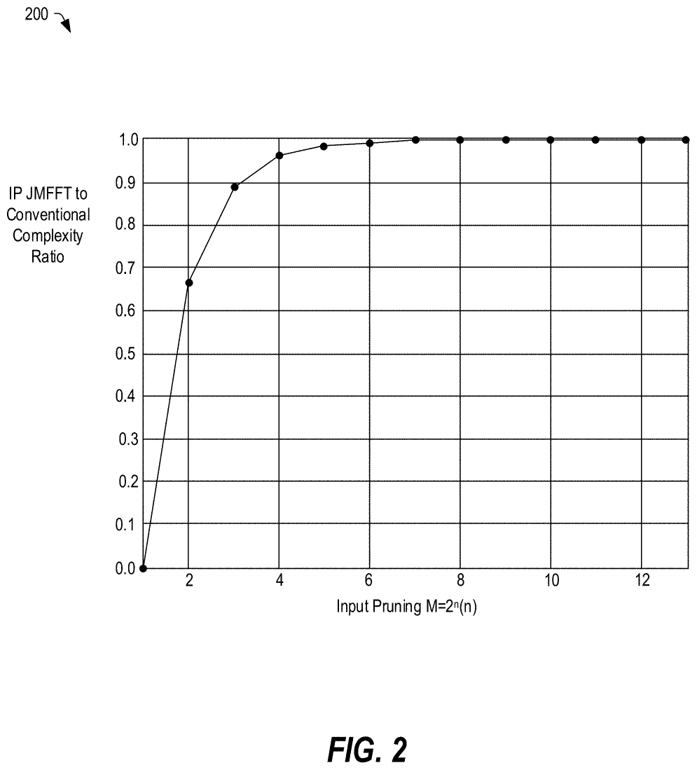

FIG. 2 depicts a graph 200 of real operations reduction versus input pruning for the generalized radix-r input/output pruning FFT of FIG. 1 compared to a conventional DIT radix-2 Cooley-Tukey algorithm. The graph 200 reveals that the complexity ratio is approximately the same.

The computational complexity of the algorithm of Equation 24 may be similar to the complexity of the DIT Cooley-Tukey algorithm. Therefore; the complexity of Equation 17 in terms of arithmetic operations for Equation 24 can be expressed as follows:

t_{c-input-IPJMFFT}=DᵢₚM(4MS_{M})=N(4MS_{M})=N(4M log₂M). (Equation 25)

For real value arithmetic operations, the complexity ratio between the low-complexity I/O pruning FFT and a conventional input pruning FFT as taught by Medina-Melendrez, et al. (M. Medina-Melendrez, M. Arias-Estrada and A. Castro, “Input and/or Output Pruning of Composite Length FFTs Using a DIF-DIT Transform Decomposition”, IEEE Transactions on Signal Processing, Vol. 57, No. 10, pp. 4124-4128, October 2009) (hereinafter “Medina”) can be determined as follows:

$${G}_{IPJMFFT / input \text{-} Puning \_ Medina} = \frac{( 4 {MS}_{M} )}{( 4 {MS}_{M} + 8 )} = \frac{( 4 M {log}_{2} M )}{( 4 M {log}_{2} M + 8 )} , \qquad ( Equation 26 )$$

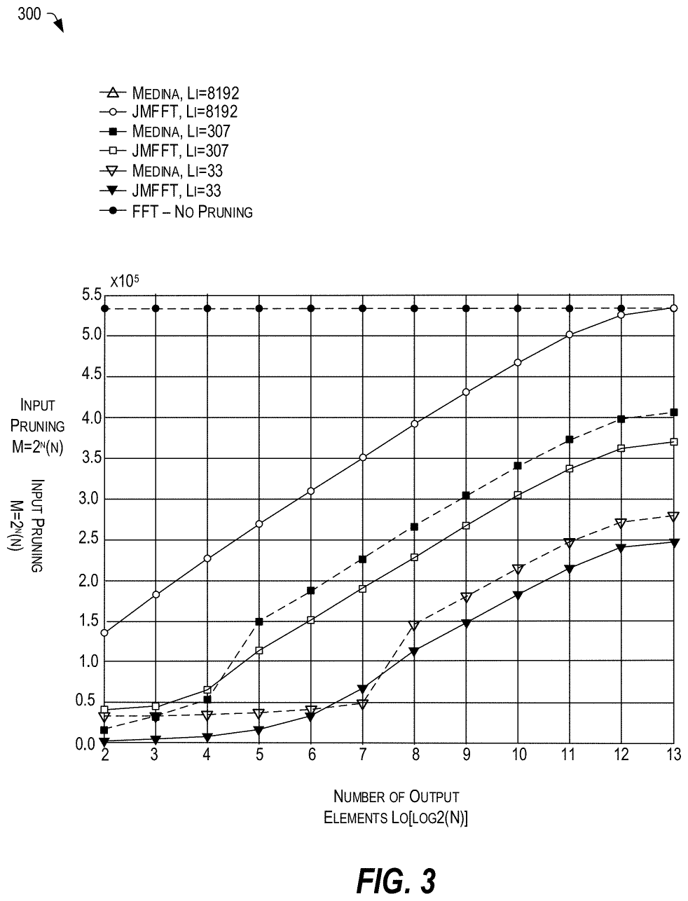

This ratio is sketched in FIG. 3 for N=8192, and the input pruning, M, changes from 2 to N.

FIG. 3 depicts a graph 300 of a complexity ratio of the generalized radix-r input/output pruning FFT according to some embodiments of the present disclosure versus the Medina FFT. In the graph 300, a complexity reduction for M<26 can be observed. In some embodiments, the complexity of the generalized radix-r I/O pruning FFT algorithm t_{c} can be computed as follows:

t_{c-Iimput/Output-JMIOPFFT}=t_{cm}(LₒDₒₚ)+DᵢₚDₒₚFFT_{P}+t_{ca/s}(DᵢₚDₒₚ+2LₒDₒₚ), (Equation 27)

Therefore, the complexity of the generalized radix-r I/O pruning FFT algorithm can be determined as follows:

$${t}_{c \text{-} Iimput / Output - JMIOPFFT} = 6 N + \frac{N}{P} ( 4 {PS}_{P} + P + 6 ) + 2 ( \frac{N}{P} + 2 N ) = 10 N + \frac{N}{P} ( 4 {PS}_{P} + P + 8 ) = N ( 4 {PS}_{P} + 11 P + 8 ) . \qquad ( Equation 28 )$$

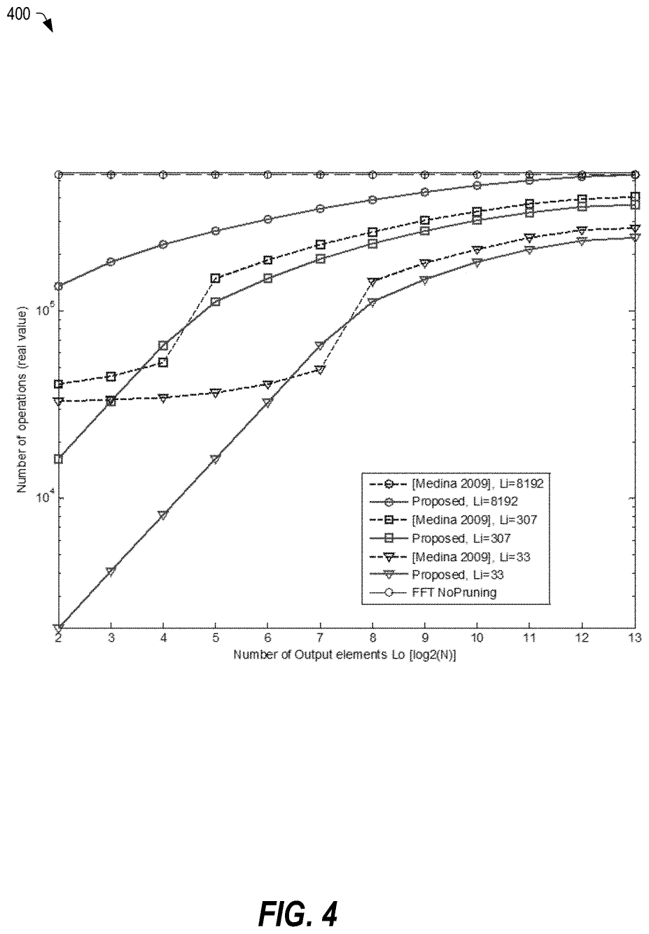

The complexity comparison between the generalized radix-r I/O pruning FFT and the Medina FFT reveals that both methods have the same complexity for Lᵢ=8192. Further, the graph 200 reveals that, for Lᵢ=307, the complexity of the generalized radix-r I/O pruning FFT algorithm is approximately equivalent to the Medina FFT algorithm for Lᵢ=33 for a number of outputs greater than 2⁸. The operation's reduction ratio between the generalized radix-r I/O pruning FFT algorithm and the Medina FFT is presented in FIG. 4.

FIG. 4 depicts a graph 400 of a number of operations versus a number of output elements for the generalized radix-r input/output pruning FFT according to some embodiments of the present disclosure versus a pruning FFT implementation. The graph 400 depicts the complexity comparison of the graph 300 of FIG. 3, but on a logarithmic scale.

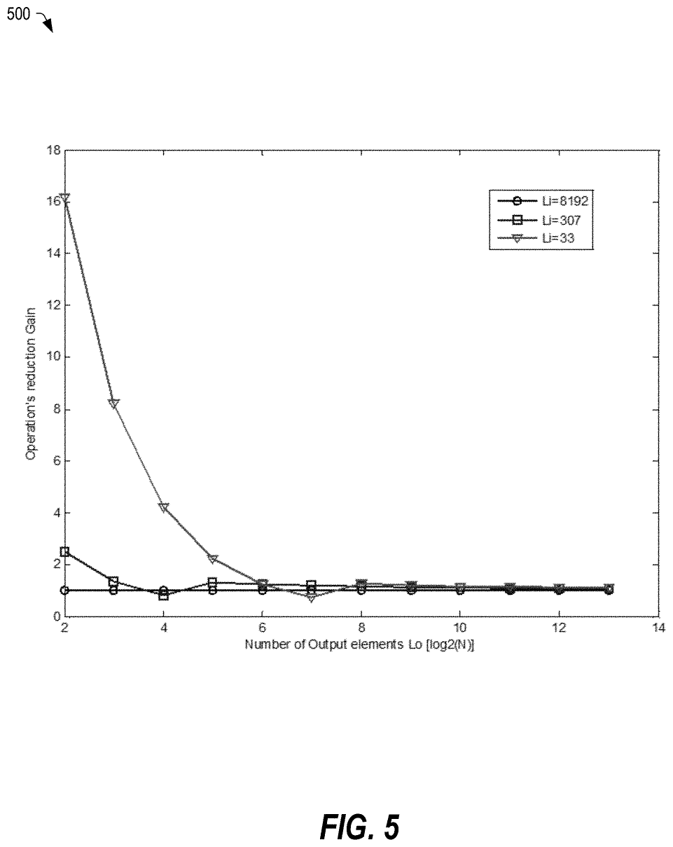

FIG. 5 depicts a graph 500 of a number of operations versus a number of output elements for the generalized radix-r input/output pruning FFT according to some embodiments of the present disclosure versus a pruning FFT implementation showing a gain.

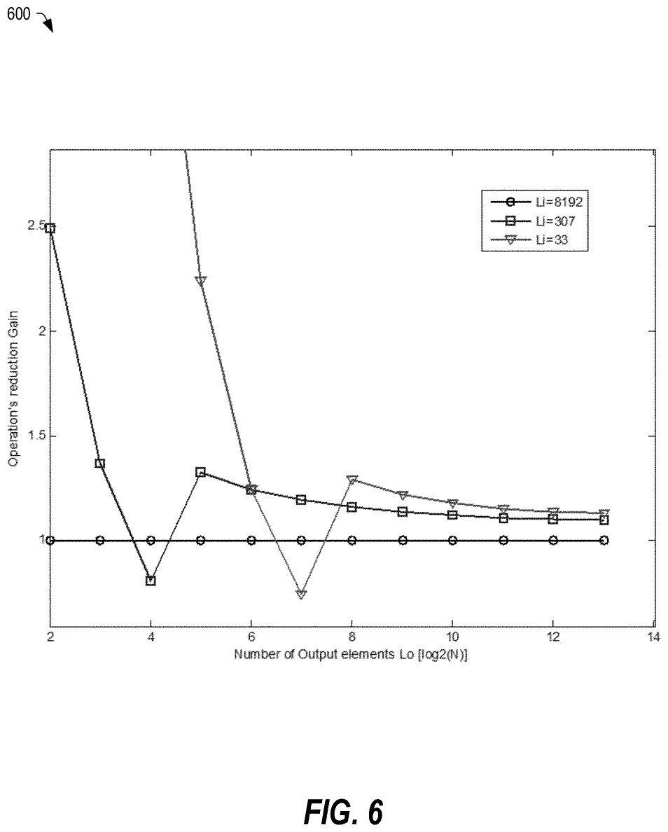

FIG. 6 depicts a graph 600 of a reduction ratio of operations versus a number of output elements, for the generalized radix-r input/output pruning FFT according to some embodiments of the present disclosure versus a pruning FFT implementation. The graph 600 is an expanded version of the graph 500 of FIG. 5.

It should be appreciated from the graphs 500 and 600 of FIGS. 4 and 6 that the generalized radix-r input/output pruning FFT demonstrates a gain that ranges between 1.4 and 1.2 for Lᵢ=307 and Lₒ>2⁸ as compared to the Medina FFT.

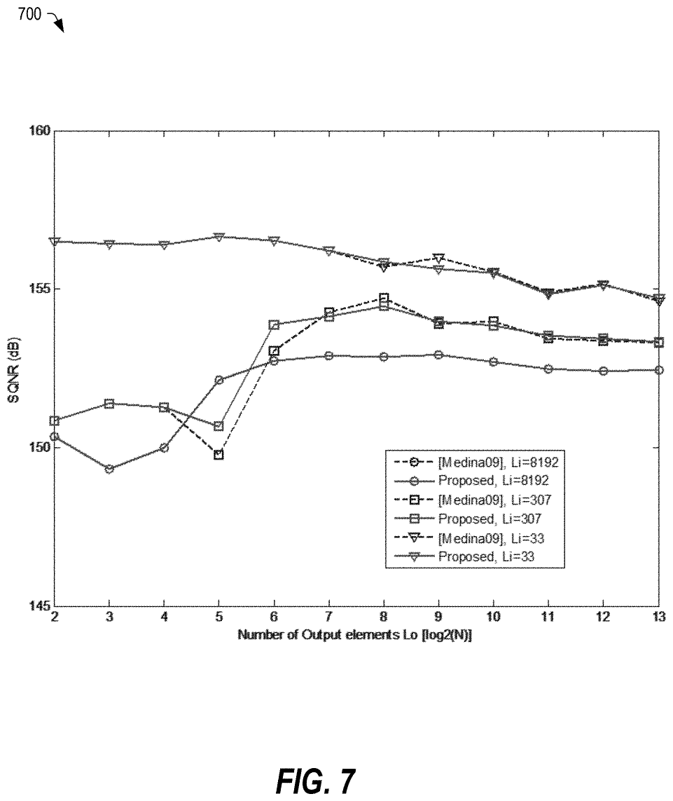

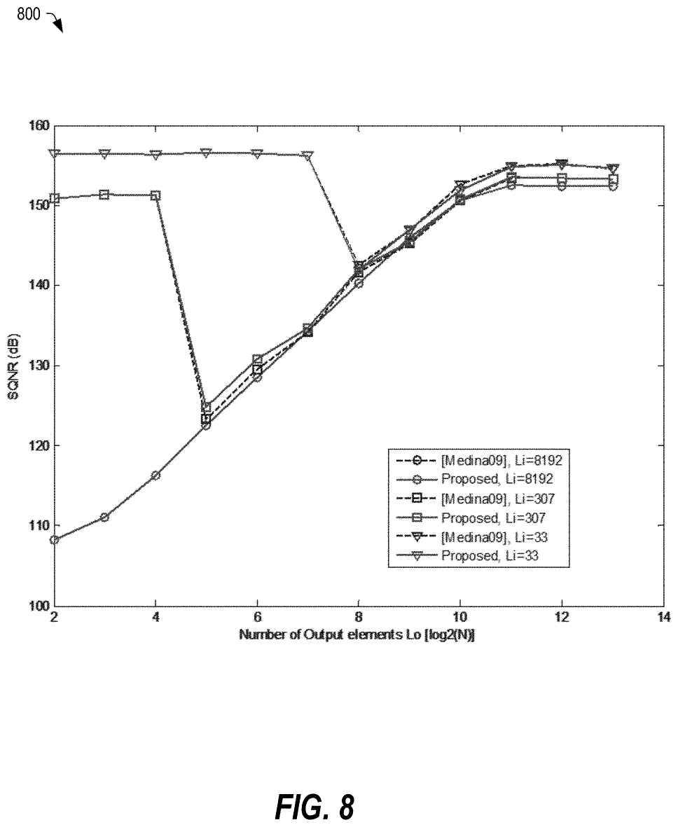

According to Equation 33, it seems that the output stage would be costly in implementation for Lₒ>Dᵢₚ. The direct method and the 2 BF filtering method proposed by Sorensen, et al. (H. V. Sorensen and C. S. Burrus, “Efficient computation of the DFT with only a subset of input or output points,” IEEE Transactions on Signal Processing, vol. 41, no. 3, pp. 1184-1199, March 1993.) can be combined for 1<Dop≤4 in order to achieve a gain estimated at 30% for large N, which can be weighed against the loss in precision as shown in FIGS. 7 and 8.

FIG. 7 depicts a graph 700 of signal-to-quantization-noise ratio (SQNR) in decibels versus number of output elements without filtering for the generalized radix-r input/output pruning FFT, in accordance with some embodiments of the present disclosure. The graph 700 shows that the generalized radix-r I/O pruning FFT of the present disclosure provides an SQNR that represents an improvement in some instances over the Medina FFT.

FIG. 8 depicts a graph 800 of signal-to-quantization-noise ratio (SQNR) in decibels versus number of output elements with filtering for the generalized radix-r input/output pruning FFT, in accordance with some embodiments of the present disclosure. With 2 BF filtering employed, the graph 800 shows that the generalized radix-r I/O pruning FFT of the present disclosure provides an SQNR that represents an improvement in some instances over the Medina FFT.

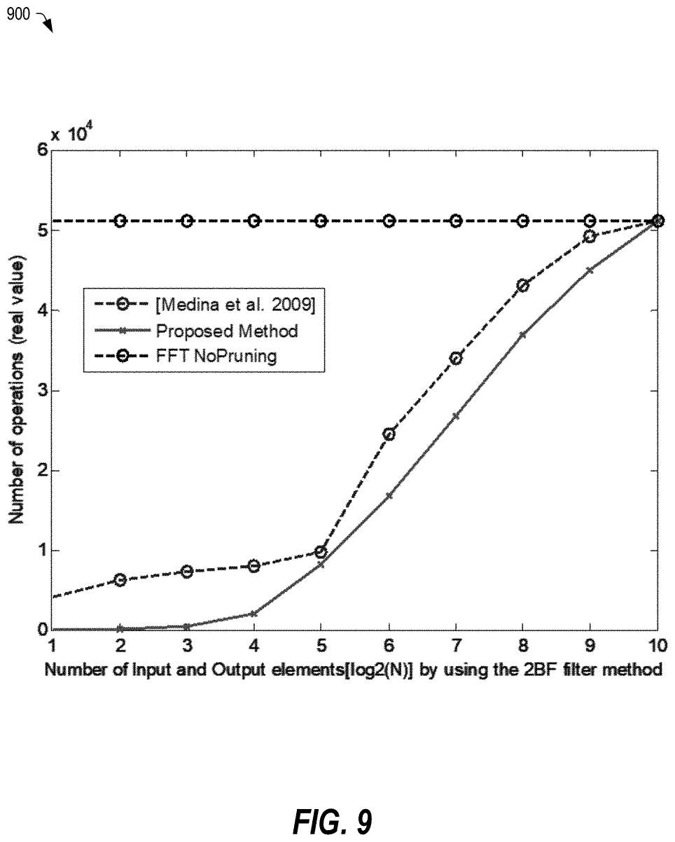

FIG. 9 depicts a graph 900 of a number of operations versus number of input/output elements for the generalized radix-r input/output pruning FFT according to some embodiments of the present disclosure versus a radix-2 Cooley-Tukey FFT implementation. In terms of complexity, the graph 900 shows that the generalized radix-r I/O pruning FFT represents an improvement over the Medina FFT.

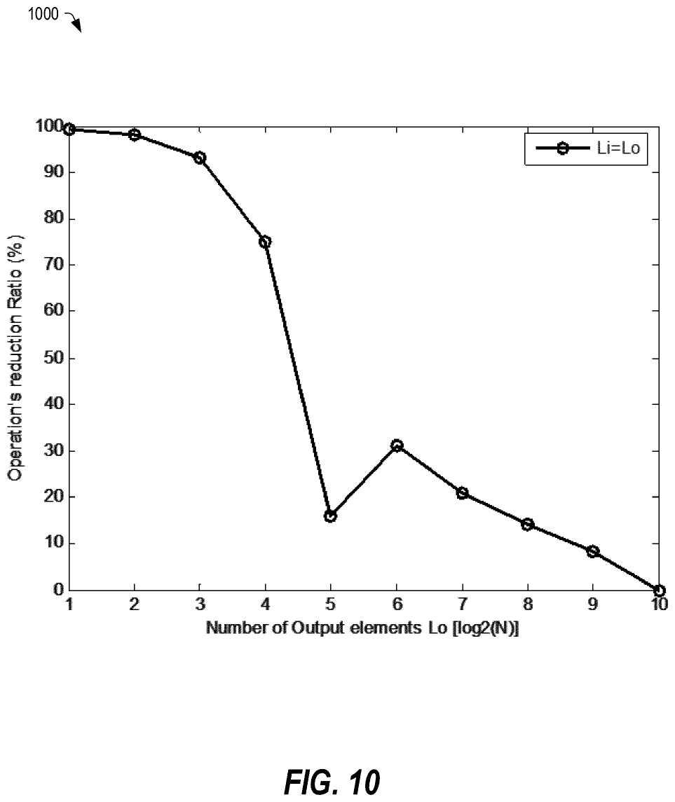

FIG. 10 depicts a graph 1000 of the reduction ratio of operations versus the number of output elements for the generalized radix-r input/output pruning FFT, in accordance with some embodiments of the present disclosure. The graph 1000 shows an operation's reduction ratio of the percentage versus the number of output elements for the FFT using a 2BF method where Lᵢ=L₀ and N=1024.

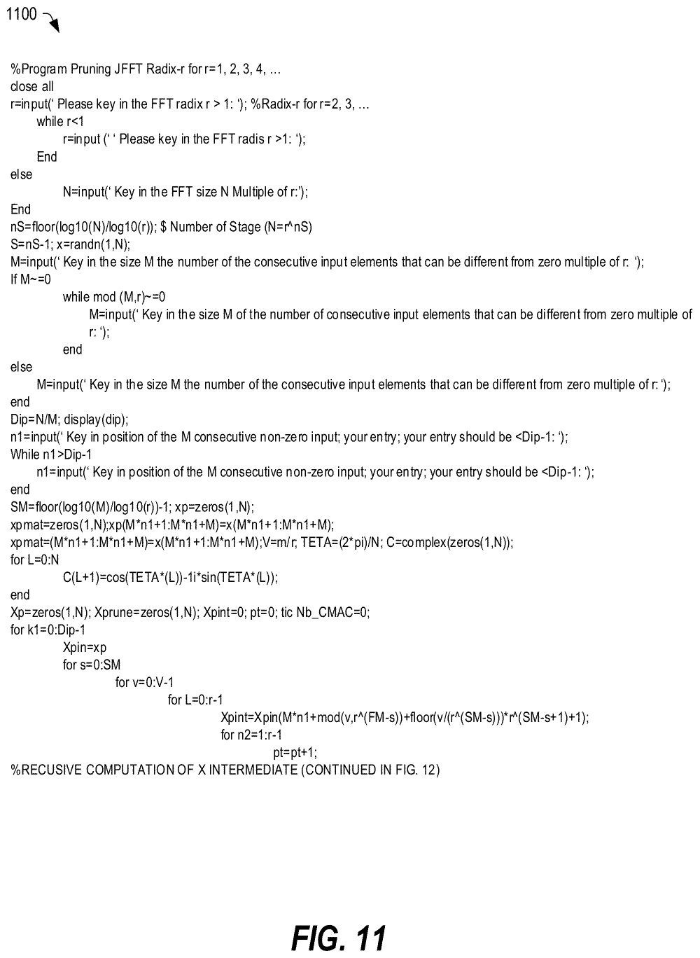

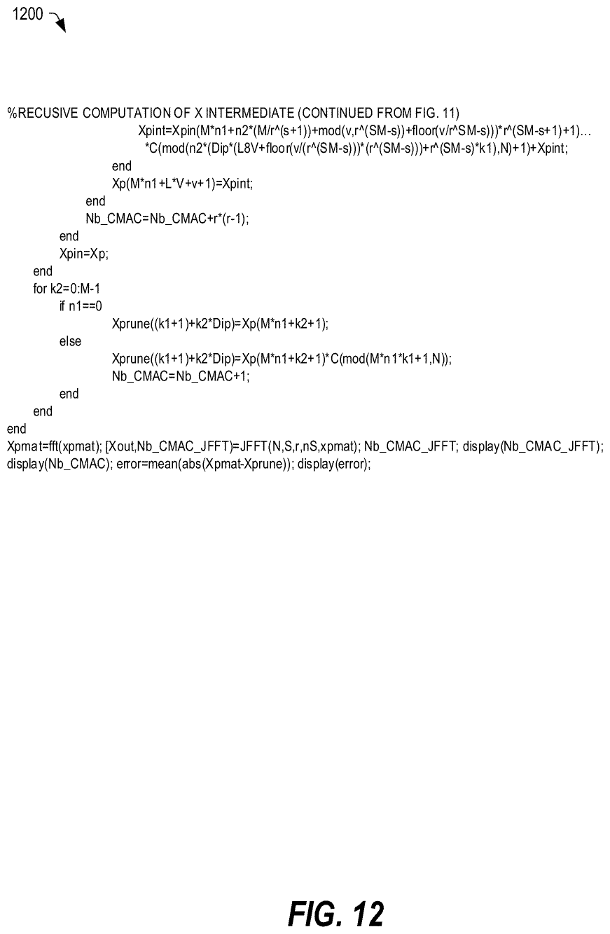

FIGS. 11 and 12 depict the software implementation of sequences that have Lᵢ (multiple of the FFT radix-r) consecutive non-zero input points at any position n (n is multiple of the FFT radix-r) within the sequence and not necessarily at the beginning. In FIG. 11, a code portion 1100 is disclosed that configures the pruning algorithm. FIG. 12 depicts a code portion 1200 that discloses the recursive computation.

It should be appreciated that the code example provided in FIGS. 11 and 12 depicts one possible implementation of the algorithm. Other implementations are also possible.

In conjunction with the systems, circuits, devices, and methods described above with respect to FIGS. 1-12, an efficient input pruning FFT is disclosed that can reduce the complexity and the computational effort used to produce the FFT outputs, as compared to conventional approaches. Further, the input pruning FFT may be used in image processing (reducing the number of operations) and in wireless communications (reducing complexity and computational effort), providing a key contribution to advances in wireless communications. In an example, reduction in computational time that can be achieved by the generalized radix-r input/output pruning FFT finds applications in the wireless communications industry, such as orthogonal frequency-division multiple access (OFDMA) applications, long-term evolution (LTE) technologies, other communications technologies, or any combination thereof.

In some implementations, an efficient radix-r input pruning FFT is disclosed that can reduce the complexity and the computational effort to produce the FFT outputs as compared to conventional approaches. Further, this approach is applied on sequences that will have Lᵢ (multiple of the FFT radix-r) consecutive non-zero input points at any position n (n is multiple of the fft radix-r) within the sequence and not necessarily at the beginning. It is an indispensable tool for the orthogonal frequency division multiplexing (OFDM) based Cognitive Radio that will be mainly based on FFT pruning, which applies efficiently zeros to the inputs with arbitrary distributions within the sequence.

Implementations that may be used within the scope of the present disclosure may be illustrated by way of the following clauses:

Clause 1: A circuit comprises an input configured to receive a signal including a plurality of input values and a radix-r input/output pruning fast Fourier transform (FFT) processing element coupled to the input. The radix-r input/output pruning FFT processing element prunes FFT operations related to a subset of the plurality of input values having a value of zero and determines, based on others of the plurality of input values, discrete Fourier Transform (DFT) output having fewer output values than a number of the plurality of input values.

Clause 2: The circuit of clause 1, wherein the circuit determines, from the signal, a sequence of the input values that includes a number of consecutive non-zero input points to determine the DFT output having a selected number of output values.

Clause 3: The circuit of any of the preceding clauses, wherein the selected number of output values is less than a total number of input values of the signal.

Clause 4: The circuit of any of the preceding clauses, wherein the radix-r input/output pruning FFT processing element is configured to provide a number (r) complex multipliers in parallel to implement each of a plurality of butterfly computations of the FFT operations.

Clause 5: The circuit of any of the preceding clauses, wherein the plurality of input values includes a number (M) of consecutive non-zero input values.

Clause 6: The circuit of any of the preceding clauses, wherein the radix-r input/output pruning FFT processing element to determine the subset of the plurality of input values from the number (M) of the consecutive non-zero input values.

Clause 7: The circuit of any of the preceding clauses, where the radix-r input/output pruning FFT processing element incorporates twiddle factors and adder tree matrices of the FFT operations into a single stage.

Clause 8: A method comprises receiving a plurality of input values and determining a subset of a plurality of input values having non-zero values. The method further includes determining a discrete Fourier Transformer (DFT) output based on the subset of the plurality of input values using a radix-r input/output pruning fast Fourier transform (FFT) and providing the DFT output including a plurality of output values to an output interface.

Clause 9. The method of clause 8, wherein a number of the plurality of output values is less than a number of the plurality of input values.

Clause 10. The method of claim 7, further comprising determining a sequence of the plurality of input values that includes a number of consecutive non-zero input points.

Clause 11. The method of claim 9, wherein the DFT output is determined from the sequence of the plurality of input values.

Clause 12: The method of claim 7, further comprising providing a number (r) of complex multipliers in parallel to determine a plurality of butterfly computations of the FFT operations.

Clause 13: The method of claim 7, wherein the plurality of input values includes a number (M) of consecutive non-zero input values.

Clause 14: The method of claim 12, further comprising determining the subset of the plurality of input values based on the number (M) of the consecutive non-zero input values.

Clause 15: The method of claim 7, further comprising incorporating twiddle factors and adder tree matrices of the FFT into a single stage.

Clause 16: A circuit comprises an input interface to receive a signal including a plurality of input values, an output interface to provide a discrete Fourier Transform (DFT) output including a plurality of output values, and a processing element to perform radix-r input/output pruning fast Fourier transform (FFT) operations on the plurality of input values to produce the DFT output. The processing element prunes FFT operations related to a subset of the plurality of input values having a value of zero and determines, based on others of the plurality of input values, the plurality of output values comprising the DFT output having fewer values than a number of the plurality of input values.

Clause 17: The circuit of clause 16, wherein the processing element determines the DFT output based on a number of consecutive non-zero input values.

Clause 18: The circuit of any of the clauses 16 through 17, wherein number of the plurality of output values are less than the plurality of input values.

Clause 19: The circuit of any of the clauses 16 through 18 wherein the processing element provides a number (r) of complex multipliers in parallel to implement each of a plurality of butterfly computations of the FFT operations.

Clause 20: The circuit of any of the clauses 16 through 19 wherein the plurality of input values includes a number (M) of consecutive non-zero input values and the processing element determines the subset of the plurality of input values from the number (M) of the consecutive non-zero input values.

Clause 21: The circuit of any of the clauses 16 through 20, where the processing element incorporates twiddle factors and adder tree matrices of the FFT operations into a single stage.

Although the present invention has been described with reference to preferred embodiments, workers skilled in the art will recognize that changes may be made in form and detail without departing from the scope of the invention.

What is claimed is:

1. A circuit comprising:
an input configured to receive a signal including a plurality of input values; and
a radix-r input/output pruning fast Fourier transform (FFT) processing element coupled to the input, the radix-r input/output pruning FFT processing element to:
prune FFT operations related to a subset of the plurality of input values having a value of zero; and
determine, based on others of the plurality of input values, discrete Fourier Transform (DFT) output having fewer output values than a number of the plurality of input values.

2. The circuit of claim 1, wherein the circuit determines, from the signal, a sequence of the input values that includes a number of consecutive non-zero input points to determine the DFT output having a selected number of output values.

3. The circuit of claim 2, wherein the selected number of output values is less than a total number of input values of the signal.

4. The circuit of claim 1, wherein the radix-r input/output pruning FFT processing element is configured to provide a number (r) complex multipliers in parallel to implement each of a plurality of butterfly computations of the FFT operations.

5. The circuit of claim 1, wherein the plurality of input values includes a number (M) of consecutive non-zero input values.

6. The circuit of claim 5, the radix-r input/output pruning FFT processing element to determine the subset of the plurality of input values from the number (M) of the consecutive non-zero input values.

7. The circuit of claim 1, where the radix-r input/output pruning FFT processing element incorporates twiddle factors and adder tree matrices of the FFT operations into a single stage.

8. A method comprising:
receiving a plurality of input values;
determining a subset of a plurality of input values having non-zero values;
determining a discrete Fourier Transformer (DFT) output based on the subset of the plurality of input values using a radix-r input/output pruning fast Fourier transform (FFT); and
providing the DFT output including a plurality of output values to an output interface.

9. The method of claim 8, wherein a number of the plurality of output values is less than a number of the plurality of input values.

10. The method of claim 8, further comprising determining a sequence of the plurality of input values that includes a number of consecutive non-zero input points.

11. The method of claim 9, wherein the DFT output is determined from the sequence of the plurality of input values.

12. The method of claim 8, further comprising providing a number (r) of complex multipliers in parallel to determine a plurality of butterfly computations of the FFT operations.

13. The method of claim 8, wherein the plurality of input values includes a number (M) of consecutive non-zero input values.

14. The method of claim 13, further comprising determining the subset of the plurality of input values based on the number (M) of the consecutive non-zero input values.

15. The method of claim 8, further comprising incorporating twiddle factors and adder tree matrices of the FFT into a single stage.

16. A circuit comprising:
an input interface to receive a signal including a plurality of input values;
an output interface to provide a discrete Fourier Transform (DFT) output including a plurality of output values; and
a processing element to perform radix-r input/output pruning fast Fourier transform (FFT) operations on the plurality of input values to produce the DFT output, the processing element to:
prune FFT operations related to a subset of the plurality of input values having a value of zero; and
determine, based on others of the plurality of input values, the plurality of output values comprising the DFT output having fewer values than a number of the plurality of input values.

17. The circuit of claim 16, wherein number of the plurality of output values are less than the plurality of input values.

18. The circuit of claim 16, wherein the processing element provides a number (r) of complex multipliers in parallel to implement each of a plurality of butterfly computations of the FFT operations.

19. The circuit of claim 16, wherein:
the plurality of input values includes a number (M) of consecutive non-zero input values; and
the processing element determines the subset of the plurality of input values from the number (M) of the consecutive non-zero input values.

20. The circuit of claim 16, where the processing element incorporates twiddle factors and adder tree matrices of the FFT operations into a single stage.
